(19) United States
(12) Patent Application Publication
(10) Pub. No.: US 2018/0217400 A1
(43) Pub. Date: Aug. 2, 2018

(54) COMPOSITE LENS STRUCTURE AND METHOD FOR PREVENTION OF CONDENSATION FOR USE IN EYEWEAR

(71) Applicant: Jacob Kon, Winston-Salem, NC (US)

(72) Inventor: Jacob Kon, Winston-Salem, NC (US)

(21) Appl. No.: 15/881,807

(22) Filed: Jan. 29, 2018

Related U.S. Application Data
(60) Provisional application No. 62/451,805, filed on Jan. 30, 2017.

(51) Int. Cl. G02C 7/02; G02C 11/00

(52) U.S. Cl. CPC G02C 7/02; G02C 11/10

(57) ABSTRACT

Provided is a composite lens structure and a method to prevent condensation buildup for use in eyewear that incorporates a glass cover slip, an electrically conductive thin film heating element, and a thermally conductive thin film intended to act as a heat spreader. The thermally conductive heat spreader accommodates for hot spots within the electrically conductive thin film heating element due to irregular geometry in eyewear. The method for heating the thin film heating element incorporates a thermal cutoff circuit intended to both heat the composite lens structure as well as preventing the thin film heater from reaching undesired temperatures. Analog circuitry may be used to determine the temperature setpoints for the thermal cutoff circuit.

### BACKGROUND

The disclosed invention and the embodiments described are in optical lens structure and prevention of condensation formation in the field of eyewear.

Eyewear, up until the mid-20^{th} century, has been typically comprised of glass lenses fixed into a frame. Advances in plastics have brought about the widespread use of transparent impact resistant plastic material as a lens in eyewear due to the low cost and increased durability. However, the transition to plastic lenses has brought about the problem of a high susceptibility to scratching. For example, safety glasses required by OSHA standards for a variety of occupations are typically low cost when it comes to the polycarbonate lens used for an impact resistant surface. When scratches start to obstruct the vision of the user of the safety glasses, the user usually discards the eyewear and sources a new pair of safety glasses. The tendency to throw away scratched lenses and replace them with a fresh lens is widespread in the usage of eyewear, a trend observed for eyewear items ranging from gas masks used by firefighters to action sports equipment users.

In addition to scratching, the issue of condensation formation has been reported as a major issue when the lenses are exposed to a thermal gradient or high humidity. Eyewear manufacturers use a variety of methods from venting to internal fans to decrease relative humidity and to decrease intensity of the differential temperature gradient between the outside lens surface and the inside lens surface. The use of anti-fog thin films is a popular choice to impede the formation of condensation on the inner lens surface. In less humidity-regulated work environments, condensation formation prompts users to simply remove fogged eye protection, the justification being that the user would rather risk eye injury than risk bodily harm due to inhibited vision. The removal of eyewear is often dangerous, especially when working with hazardous chemicals. In recent years, the use of transparent electrically conductive materials for use in thermal lenses has emerged in various forms to combat fogging of the internal lens surface.

In lenses designed for high impact, the use of polycarbonate or similar high elasticity plastic is widespread in eyewear categories such as action sports and safety. The environmental conditions the plastic lenses are exposed to which necessitate the use of the high impact materials are often hostile to the lens surface and susceptible to abrasion. The use of a thin film hardcoat is often used to help protect the soft optical surface of the plastic lens material, offering an increased surface hardness for the lens.

Glass lenses are still actively in production for use in corrective glasses and sunglasses intended for use in casual environments without the need to withstand impact. The use of mineral glass for a lens material presents effectively no harmful scenario to the eye for casual use and can be deemed appropriate.

### BRIEF SUMMARY OF THE INVENTION

Provided is a composite lens structure comprised of a durable thermoplastic structural element, glass cover slip, transparent thermally conductive material, and a transparent electrically conductive material for use in personal protection eyewear; the composite lens structure incorporating the mentioned components independently or optionally combined together.

Recent advances in thin glass make possible new combinations of glass and plastics to create a lens with high impact resistance and increased surface hardness. The disclosed composite lens structure seeks to provide the best qualities of both glass and plastic lenses. Cost reductions made popular by the use of glass in smartphones touchscreens and in other touchscreen electronics enable the designer to justify use of the glass composite lens in new eyewear products.

The disclosed lens structure may be utilized in devices to protect the eyes during intense activities, such as within eyewear intended for outdoor use. The eyewear may optionally contain thin film heating elements for the removal or prevention of condensation. The electrically heated thin film may be optionally comprised of a silver thin film or indium tin oxide on a flexible transparent substrate. The flexible transparent substrate may optionally be comprised of a PET material.

In some embodiments, a thermally conductive layer may be embedded adjacent to the lens in thermally conductive contact with the electrically heated thin film. Hot spots are created due to utilization of a single continuous region of electrically conductive transparent material placed over irregular geometry. The thermally conductive layer may be used to act as a heatsink to compensate for said hot spots in the electrically heated thin film.

In some embodiments, polycarbonate can be used as the lens material and the transparent conductive material may be bonded to the inner surface of the lens using an optical adhesive. The optical adhesive may be a peel off sheet with two protective layers placed adjacent to either side of the adhesive or, optionally, a liquid optically clear adhesive deposited onto the lens surface.

In some embodiments, the polycarbonate material may retain a glass cover slip to the exterior surface using an optically clear adhesive. In addition to the peel off optically clear adhesive, a liquid optically clear adhesive may optionally be used to adhere the glass cover slip to the exterior surface of the lens.

In some embodiments, the glass cover slip may optionally be chemically strengthened to increase surface hardness and decrease the minimum bend radius required by the thin glass cover slip thickness. The glass cover slip may be strengthened by use of a potassium nitrate salt bath for at least one hour to achieve the decrease in minimum bend radius.

Potential uses for the lens structure include prevention of condensation formation and increased durability in safety eyewear. Additional value for the chemically-strengthened glass cover slip is realized in the recreational sports industry, where costly lens replacements are warranted after a major scratch.

### BRIEF DESCRIPTION OF THE DRAWINGS

FIG. 1 is a detail view of a lens composed of a transparent electrically conductive element, an optically clear adhesive, and an optically transparent plastic material with hot spot locations illustrated for the transparent electrically conductive element when used as a thin film heater.

FIG. 2 is a section view of a lens with bus bars attached comprised of an optically transparent plastic material, a transparent thermally conductive material, and a transparent conductive material mounted on a suitable flexible substrate.

FIG. 3 is front view of a lens used in a pair of eyeglasses with hot spot locations, bus bar locations, and potential temperature sensor locations indicated.

FIG. 4 is a cross section of a lens comprised of a composite incorporating an optically transparent plastic material, multiple layers of transparent thermally conductive material, and transparent electrically conductive material.

FIG. 5 is a flowchart of a method intended to prevent condensation formation on the interior surface of eyewear upon which the method is applied.

FIG. 6 is a cross section of a lens incorporating a composite lens utilizing an optically transparent plastic upon which a glass cover slip has been mounted via an optical adhesive.

FIG. 7 is a diagram describing a method to prevent condensation formation through regulation of a thin film heater utilizing a thermal cutoff circuit.

### DETAILED DESCRIPTION OF DRAWINGS AND BEST MODE OF IMPLEMENTATION

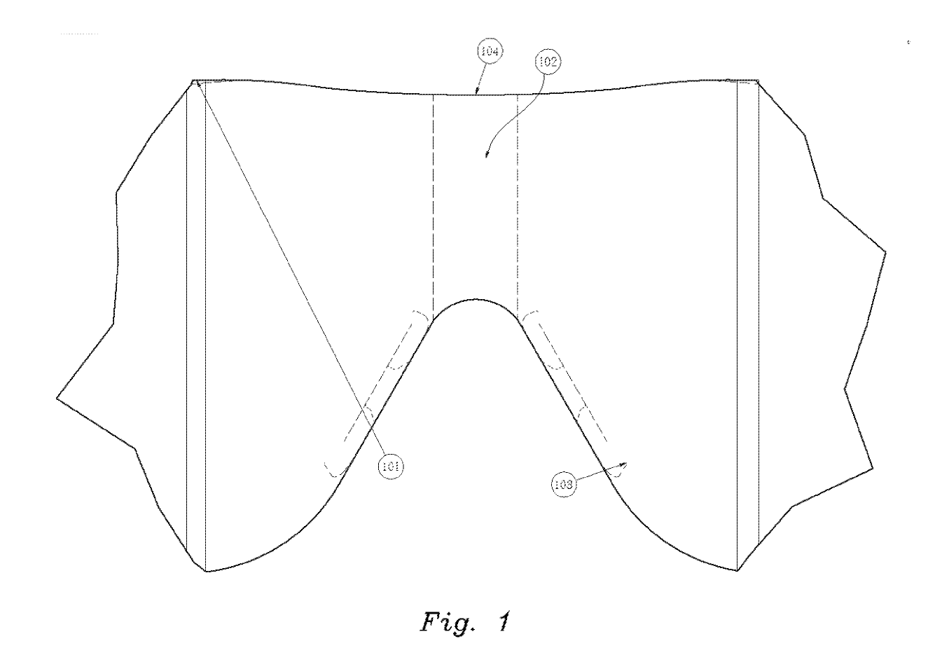

FIG. 1 is a front detail view of a lens structure incorporating a transparent electrically heated thin film used for prevention of condensation through heating of lens 104 depicted. The bus bar 101 mounted on the transparent conductive layer is optimally extending vertically across the entire lens surface of lens 104 to provide minimal resistance for the transparent electrically conductive material. The hotspot 102 is located in the most vertically narrow segment between the bus bars attached to lens 104 due to the geometry induced to accommodate a human nose. As the hotspot 102 is unavoidable without breaking up the transparent conductive layer into multiple regions; the current density is limited by the geometry and the area indicated by 103 receives a lower power density due to the increased distance away from the opposing bus bar 101.

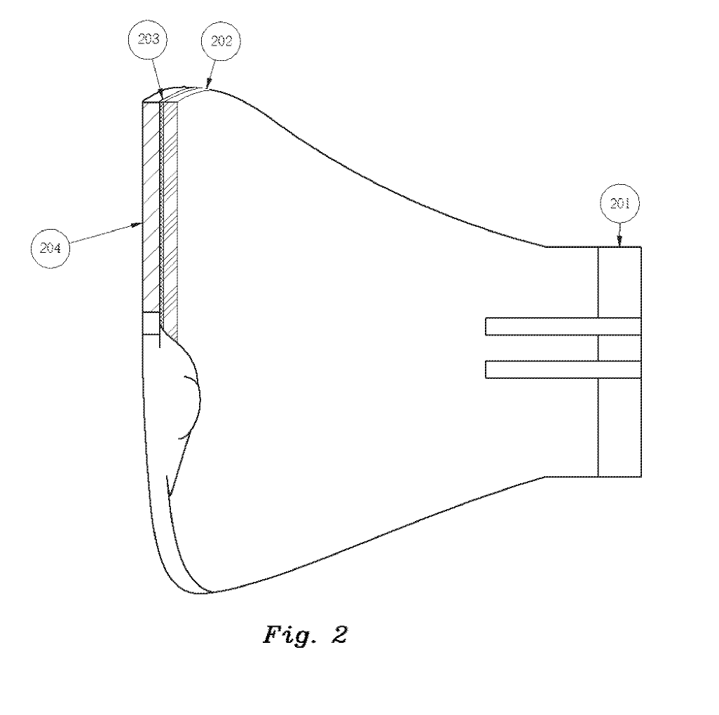

FIG. 2 illustrates a cross section of an embodiment of a composite lens structure incorporated in glasses 200. The bus bar 201 located on the periphery of the lens may be electrically connected across the lens surface while in electrical contact with the transparent electrically conductive layer 202. Ideally, the transparent electrically conductive layer 202 may be made of indium tin oxide may be mounted to a flexible thermoplastic substrate to serve as an electrically insulative and protective layer. The transparent thermally conductive material 203 is adhered adjacent to the transparent electrically conductive layer 202 for material 203 to act as a heat spreader. The structural element 204 may be optionally made from impact-resistant materials such as polycarbonate.

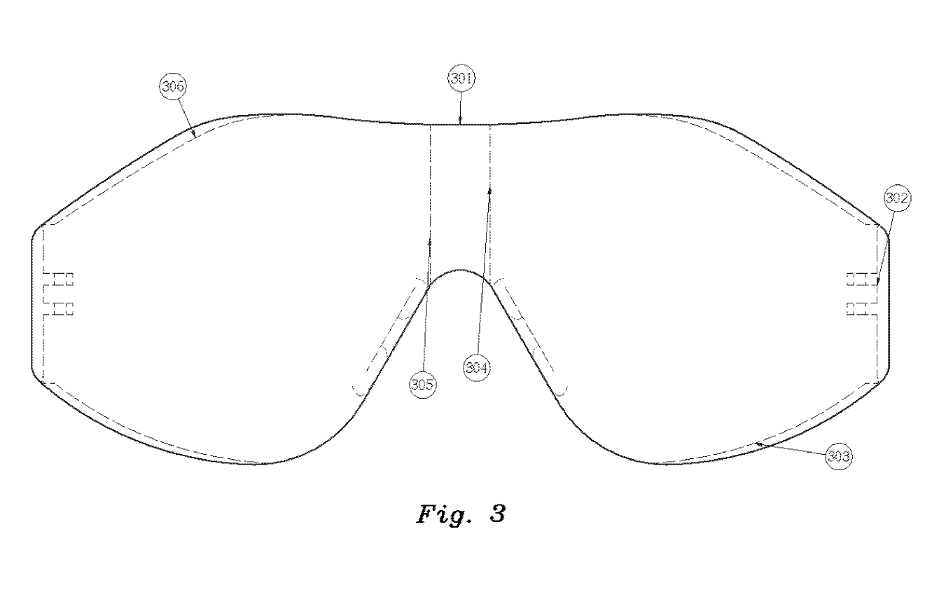

FIG. 3 shows the front view of an eyeglasses embodiment in the form of glasses 301 illustrating power density variation across the single region of the transparent electrically conductive material. The region 305 can be considered the area in which power density is the highest for a thin film heater of geometry illustrated in eyeglasses 301. In order of descending power density values, the areas 304, 306, and 303 can be calculated based on the geometry of the lens shape between the transparent conductive material bus bar 302, vertically extended across the lens surface, and the opposing bus bar.

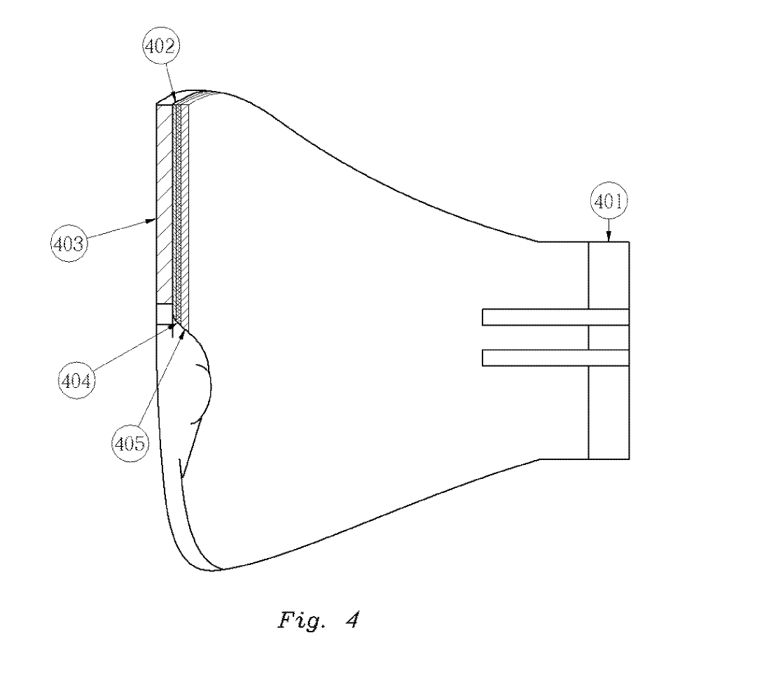

FIG. 4 shows a cross section of an eyeglasses embodiment of FIG. 2, where a bus bar 401 extends vertically across the lens and in electrical contact with the transparent conductive layer 404. Ideally, a transparent thermally conductive layer 402 can be included in between the structural layer 403 and the transparent conductive layer 404 to act as a heatsink, distributing the thermal energy density throughout the inner surface of eyeglasses 400. Optionally, an additional thermally conductive thin film 405 that may be electrically insulative may be placed to improve distribution of the thermal energy across the interior surface of eyeglasses 400. The illustrated eyeglasses embodiment 400 can include one or more batteries integrated into, or otherwise attached onto, the frame of the eyeglasses 400 to power the thin film heating circuit with thermal cutoff utilizing temperature sensors in thermally conductive contact with the thermally conductive layer 405.

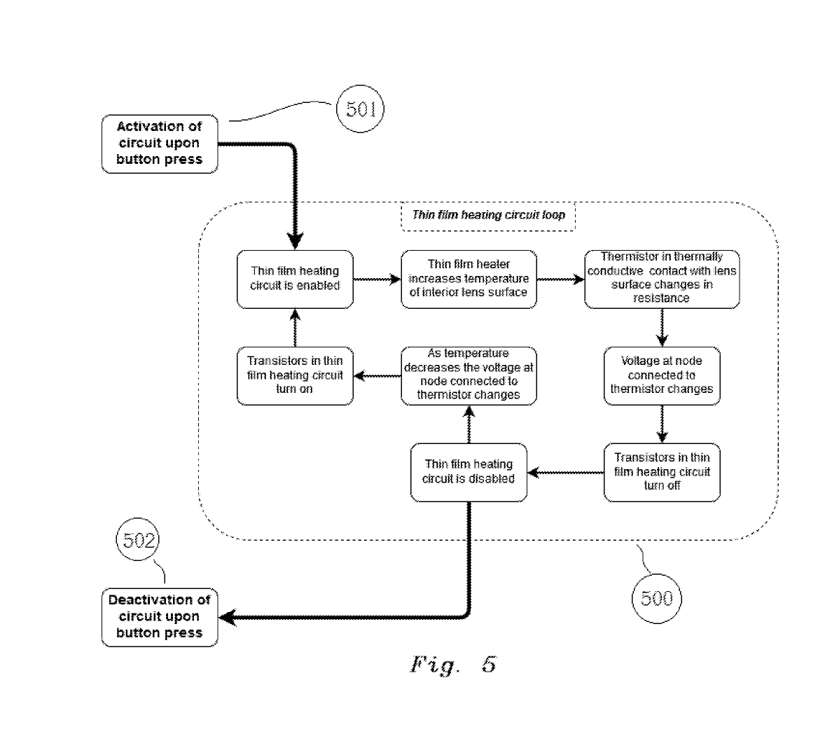

FIG. 5 shows the method for condensation buildup prevention of the disclosed composite lens embodiment illustrated in FIG. 2 and FIG. 4. Circuit activation 501 describes a method in which a user activates a thin film heating circuit loop 500 via a button press. The circuit activation 501 enables the thin film heating circuit loop 500 to begin dispersing heat on the interior lens surface. As the thin film heating circuit loop 500 progressively increases in temperature, a thermistor 706 in thermally conductive contact with the lens may be used to drive at least one transistor 704 in a voltage divider 705. As the temperature of the negative thermal coefficient thermistor 706 increases, the voltage seen at the gate of transistor 704 decreases to drive the transistor 704 to the off condition. The loop 500 may optionally be continued indefinitely or until the user deactivates the heating circuit loop 500 by pressing the deactivation button 502.

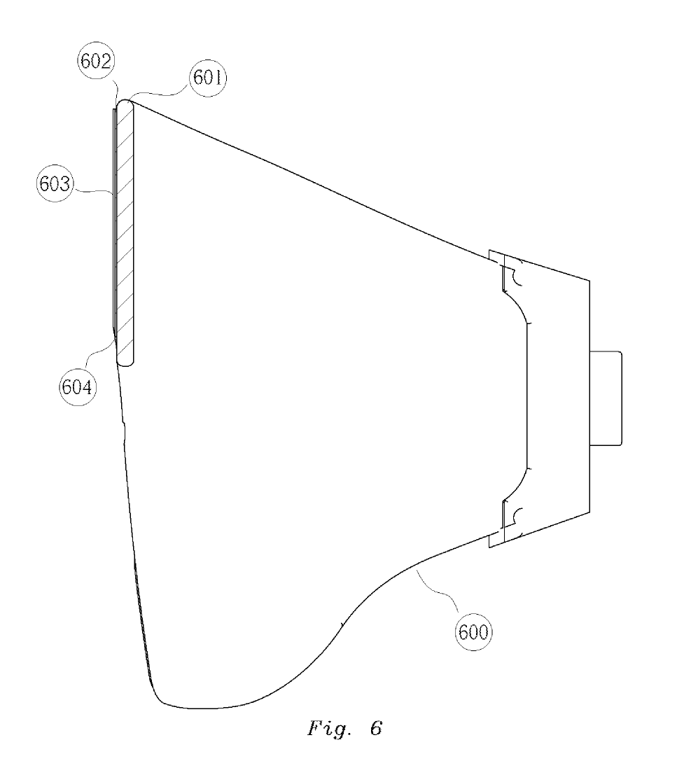

FIG. 6 is a cross section of an eyeglasses embodiment comprised of a composite lens structure incorporating a glass cover slip 603. The glass cover slip 603 is attached to an optically transparent plastic material 601 via an optical adhesive 602. A sealant 604 separates the optically clear adhesive from environmental conditions, the sealant optionally being comprised of silicone.

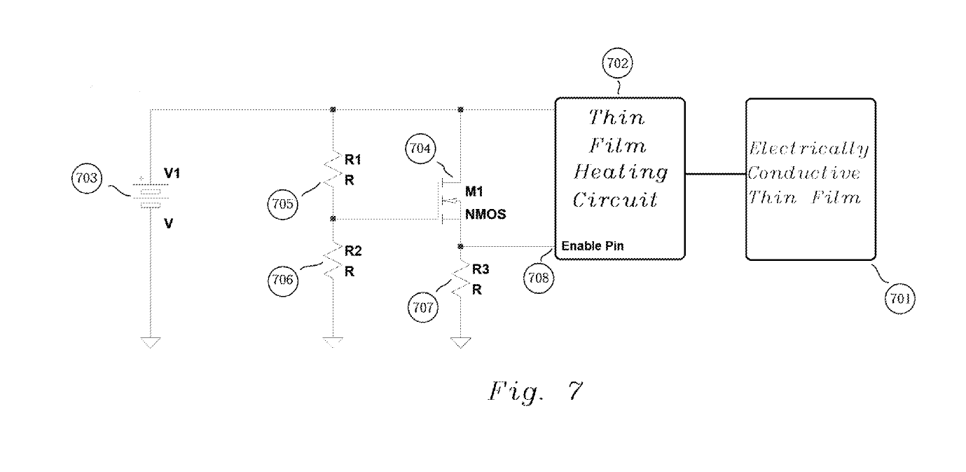

FIG. 7 is a diagram illustrating an embodiment comprised of a metal oxide semiconductor field effect transistor 704 used in a thermal cutoff circuit controlling an optional enable pin 708 which ideally is integrated into a thin film heating circuit 702 that may be an application specific integrated circuit. The gate voltage of transistor 704 is controlled by voltage divider circuit 705 optionally utilizing a negative thermal coefficient thermistor 706 in thermally conductive contact with the electrically conductive thin film 701. The transistor 704 is turned on when the temperature of thermistor 706 is at a level determined to be acceptable by the circuit designer, allowing voltage from voltage source 703 to pass through to the enable pin 708 to turn on the thin film heating circuit 702. As the heating circuit 702 heats the electrically conductive thin film 701 above the temperature setpoint set by the designer, the thermistor 706 decreases in resistance, eventually turning transistor 704 to the off state. As the enable pin 708 is no longer at a voltage level across resistor 707, the ground voltage level is fed into the enable pin 708 and the electrically conductive thin film 701 is no longer heated.

Although an embodiment utilizing the method for heating eyewear have been described herein, the various features described can be changed or combined to provide additional embodiments utilizing the method and the disclosed embedded system. While some variations have been illustrated in detail, other modifications which are within the scope of the disclosed invention will be apparent to those of skill in the art based on the disclosed invention. This disclosure is not intended to be limited by the disclosed embodiments for the described scope.

### REFERENCES

### Incorporated Herein by Reference

U.S. Pat. No. 6,470,696, U.S. Pat. No. 6,834,509, U.S. Pat. No. 6,886,351, U.S. Pat. No. 9,072,591, US20130091623A1, US20140027436A1, US20140033409A1, US20140374402A1, U.S. Pat. No. 5,471,036, U.S. Pat. No. 5,319,397, U.S. Pat. No. 4,209,234, U.S. Pat. No. 4,150,443, U.S. Pat. No. 3,160,735, U.S. Pat. No. 1,963,990

What is claimed is:

1. A composite lens structure for use in eyewear comprising:
a transparent plastic material;
an optical adhesive;
a glass cover slip.

2. The composite lens structure of claim 1 further comprising:
an electrically conductive transparent material.

3. The composite lens structure of claim 1 wherein the transparent structural element is composed of polycarbonate.

4. The composite lens structure of claim 1 wherein the transparent structural element may be comprised of surface geometry to provide an optical correction.

5. The composite lens structure of claim 1 wherein the glass cover slip is comprised of a chemically strengthened glass.

6. The composite lens structure of claim 2 wherein the electrically conductive transparent material is in thermally conductive contact to a thermally conductive thin film.

7. The composite lens structure of claim 2 wherein the thermally conductive thin film is in thermally conductive contact with a thermal sensor.

8. The composite lens structure of claim 2 wherein an optical adhesive is applied on the surface of the lens closest to the eyes with the electrically conductive transparent material adhered to the subject optical adhesive.

9. The composite lens structure of claim 1 wherein the edge of the composite lens is sealed using a silicone material.

10. A composite lens structure for use in eyewear comprising:
a transparent plastic material;
an optical adhesive;
a thermally conductive thin film;
an electrically conductive thin film.

11. The composite lens structure of claim 10 wherein the electrically conductive thin film is comprised of a thin film of silver nanowires.

12. The composite lens structure of claim 10 wherein the electrically conductive thin film is comprised of a thin film of indium tin oxide.

13. The composite lens structure of claim 10 wherein the thermally conductive thin film is in thermally conductive contact to a thermal sensor.

14. A method for electrically heating a transparent thin film within a composite lens structure to prevent condensation build up comprising:
activation of a thin film heating circuit upon button press;
continue heating until a thermal cut-off circuit is activated;
wait until thermal cut-off circuit is below a set value;
reactivate circuit to heat thin film until thermal cut-off circuit activated;
deactivation of the thin film heating circuit upon button press.

15. The method of claim 14 wherein the thermal cut-off circuit is comprised of analog components using one or more transistors to turn off when a certain resistance is reached by one or more thermistors.

16. The method of claim 14 wherein the thermal cut-off circuit is comprised of a mixture of analog and digital components.

17. The method of claim 16 wherein the digital components are controlled by means of a microcontroller.

18. The method of claim 17 wherein the thin film heating circuit is activated via an enable signal from the microcontroller.

19. The method of claim 17 wherein the thin film heating circuit is deactivated upon sensing a low voltage from an electric power source.

20. The method of claim 14 wherein the electric power source is a battery.
